(19) United States
(12) Patent Application Publication
(10) Pub. No.: US 2013/0269095 A1
(43) Pub. Date: Oct. 17, 2013

(54) Urine Collection Device

(71) Applicant: Lisa Finley, El Mirage, AZ (US)

(72) Inventor: Lisa Finley, El Mirage, AZ (US)

(21) Appl. No.: 13/860,050

(22) Filed: Apr. 10, 2013

Related U.S. Application Data
(60) Provisional application No. 61/622,618, filed on Apr. 11, 2012.

(51) Int. Cl. A61G 9/00

(52) U.S. Cl. CPC A61G 9/003
USPC 4/453; 4/455

(57) ABSTRACT

A urine collection device for redirecting urine away from a human body is disclosed. The urine collection device comprises a bed pan with a flushing element and an outlet. Urine flows out of the bed pan after each use through a flexible tubing and into a urine collection receptacle. The urine collection receptacle has the capacity to allow a user to void multiple times without the need to empty the bed pan after each use. Additionally, a urinal with a flushing element and an outlet may be employed with the flexible tubing and the urine collection receptacle.

### CROSS-REFERENCE

This application claims priority from Provisional Patent Application Ser. No. 61/622,618 filed Apr. 11, 2012.

### FIELD OF THE INVENTION

This invention pertains generally to a urine collection device for directing urine away from a user and more particularly to a system for redirecting urine from a user of a bed pan and/or a urinal.

### BACKGROUND

Bedridden or low mobility persons, such as hospital or nursing home patients, often require the use of a bed pan or a urinal to relieve themselves. However, conventional bed pans are often unsanitary and uncomfortable to use. The user's buttocks and genitals can easily become submerged or come into contact with urine, which may cause urinary tract infections, skin rashes, or bed sores. Additionally, conventional bed pans and urinals can easily spill, causing a mess and spreading germs. If the bed pan or urinal is already full from prior use, the user is forced to wait uncomfortably until someone comes and empties the contents before they can relieve themselves again. This issue is compounded if the user is under medical care and unable to wait to urinate. These patients are often forced to wet the bed if nursing assistance is not immediately available.

Consequently, there exists a need for a way for a person to use a bed pan or urinal multiple times without the need for a caregiver to be in constant attendance. The present invention discloses a urine collection device that redirects urine away from a user. The device is designed to allow urine to drain out of the bed pan or urinal into a remote urine collection receptacle for later disposal. As such, the bed pan or urinal need not be emptied every time a user voids. This is extremely beneficial in understaffed medical facilities freeing staff to take care of more pressing medical issues while still allowing patients to take care of a normal bodily function in a more sanitary and comfortable manner. It also prevents accidental spillage of urine onto a patients' bedding or clothes. Furthermore, the invention is designed to be flushed or cleaned after every use decreasing the likelihood of disease transmission or a distasteful disposal process as the urine is drained into a closed container.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a urine collection device for allowing a user to void their bladder multiple times without needing to empty the device after every use. The urine collection device comprises a bed pan, a urine collection receptacle, and a flexible tubing for transferring the urine between the bed pan and the urine collection receptacle. Additionally, a flushing element in the bed pan allows a user to rinse out and disinfect the bed pan after every use and in between final disposal of the urine.

Furthermore, in a preferred embodiment, a system for redirecting urine is disclosed in which the urine collection receptacle and the flexible tubing connection are useable with either the bed pan or a urinal. The bed pan may resemble a typical bed pan with an outlet nozzle for drainage. The flexile tubing may clamp to a bed rail for support. A urine collection receptacle receives and stores the drained urine for later removal after multiple uses. A flushing element may store a disinfecting solution and comprise a plurality of liquid dispensing nozzles to direct the disinfecting solution across a bottom portion of the bed pan. When not in use, the system may be stored in a bed pan holder that may also be attached to the bed rail.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective overhead view of a urine collection device in accordance with the disclosed architecture.

FIG. 2 illustrates a side view of the urine collection device in accordance with the disclosed architecture.

FIG. 3 illustrates a perspective view of a system for redirecting urine in accordance with the disclosed architecture.

FIG. 4 illustrates a perspective view of the system for redirecting urine in a disconnected condition in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

The present invention discloses a system for redirecting urine away from a human body. The preferred embodiment comprises a bed pan and a urinal for allowing a male or female user to void urine while in bed without the need to empty the bed pan or urinal after each use. The urine is directed out of the bed pan or the urinal through an outlet into a flexible tubing that empties in a urine collection receptacle for storage. The system further comprises a flushing element to keep the bed pan and/or the urinal sanitary between uses. The system is useable by health care facility patients, the elderly, the injured, and individuals with limited mobility while increasing user comfort and decreasing the likelihood of infections or spillage.

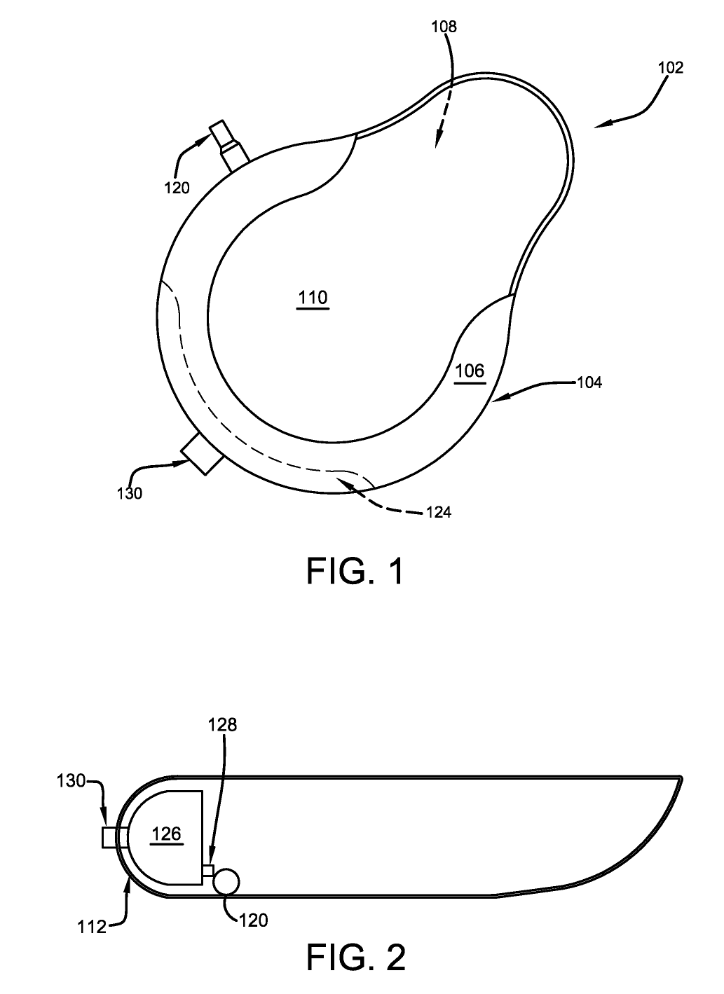

Referring initially to the drawings, FIGS. 1 and 2 illustrate a urine collection device 100 designed to redirect urine away from a human body. The urine collection device 100 comprises a bed pan 102, a flexible tubing 132 and a urine collection reservoir 144. The bed pan 102 comprises an exterior portion 104, an interior portion 108, an outlet 120, and a flushing element 124. The exterior portion 104 comprises a seating surface 106 so that when the bed pan 102 is in use, the seating surface 106 is slid underneath a user's buttocks. The interior portion 108 comprises a bottom 110 extending into a curved sidewall 112 and terminating underneath the seating surface 106.

The bed pan 102 is generally constructed of plastic, such as a medical grade plastic, a thermoplastic, a non-Bisphenol A polycarbonate plastic, and the like, although any other suitable material may be used to manufacture the bed pan 102 as is known in the art without affecting the overall concept of the invention. Furthermore the bed pan 102 resembles a typical bed pan that is generally rounded or oval in shape and with a hollow interior for collecting urine. The outlet 120 is penetrates the curved sidewall 122 where it intersects the bottom 110 of the bed pan 102 to promote drainage. The outlet 120 is typically a nozzle with a one-way valve for preventing backflow of urine into the bed pan 102. The outlet 120 may further comprise a cap (not shown) to prevent leakage in the event of a bowel movement.

The flushing element 124 is housed within the hollow interior of the bed pan 102 adjacent to the curved sidewall 112 substantially underneath the seating surface 106. Preferably, the flushing element 124 is located at a rear 118 of the bed pan 102, but may be located anywhere along the curved side wall 112 as well. The flushing element 124 comprises a fluid retaining reservoir 126, a plurality of liquid dispensing nozzles 128 and a trigger 130. The fluid retaining reservoir 126 is a refillable container capable of holding between approximately eight and 32 ounces of fluid. The fluid retaining reservoir 126 may contain any fluid useful for flushing the bed pan 102 such as but not limited to water, sanitizing solutions, disinfectants, and the like. The trigger 130 is typically a piston pump trigger, however this is not meant as a limitation as the trigger 130 may also be a spring trigger, a battery operated trigger, and the like, or any other type of trigger as is known in the art.

The fluid retaining reservoir 124 is attached to the curved sidewall 112 with adhesives, mechanical fasteners, and the like, or by any other means of attachment known to one of skill in the art. The fluid retaining reservoir 124 may also be molded into the curved sidewall 112 as well. Furthermore, the trigger 130 transects the curved sidewall 112 such that the trigger 130 is accessible from the exterior portion 104 of the bed pan 102. In other words, the user does not need to reach inside the bed pan 102 to activate the trigger 130. When the trigger 130 is activated, the fluid contained within the fluid retaining reservoir 126 is forced out of the plurality of liquid dispensing nozzles 128 into the interior portion 108 of the bed pan 102.

The plurality of liquid dispensing nozzles 128 are located so that the fluid will travel out across the interior portion 108 of the bed pan 102 thereby rinsing any residual un-drained urine out of the bed pan 102. The plurality of liquid dispensing nozzles 128 may discharge the fluid in a straight stream, an arcuate pattern, a mist, or any other pattern or combination thereof that will be effective to rinse out the interior portion 108 of the bed pan 102. Approximately between one and four milliliters of fluid is dischargeable with each activation of the trigger 130. Once the interior of the bed pan 102 is rinsed, the fluid drains out of the outlet 120 in a similar manner as the urine.

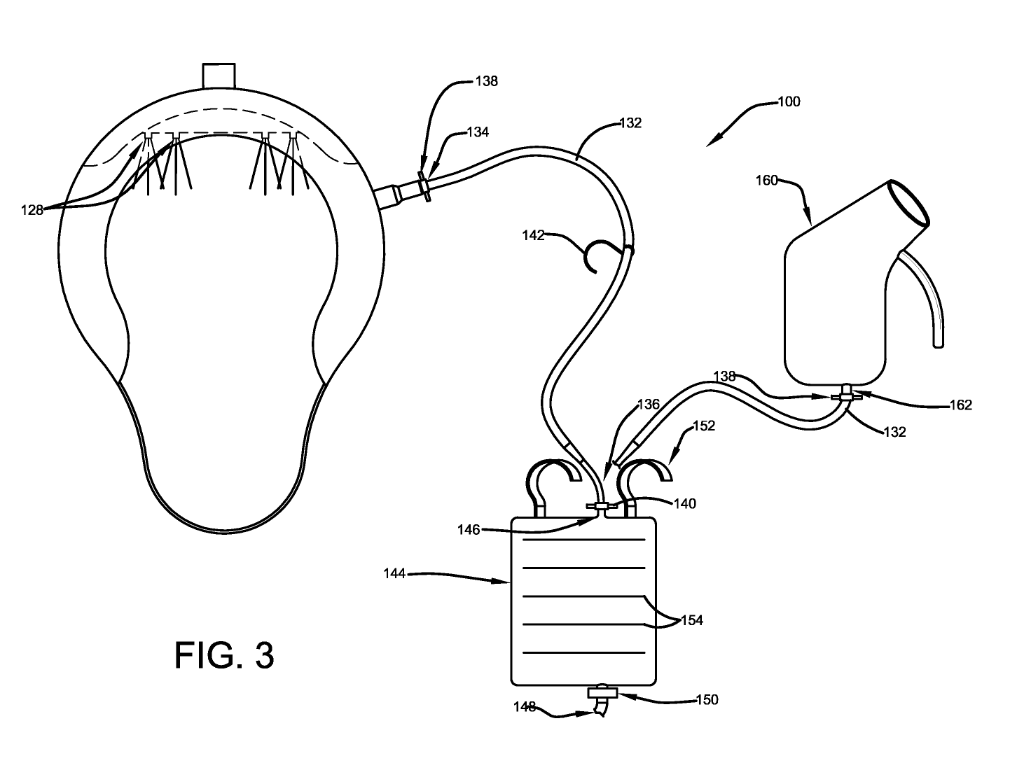

As illustrated in FIG. 3, the flexible tubing 132 is generally a section of medical grade tubing approximately between three and six feet in length with a diameter of approximately between ⅛ and ½ inches. The flexible tubing 132 comprises a first end 134 attachable to the outlet 120 of the bed pan 102, and a second end 136 attachable to the urine collection reservoir 144. The first end 134 generally slides over the nozzle of the outlet 120 from the bed pan 102 and may be further secured with a first clamp 136 as desired. Additionally, an attachment element 142 may be used to secure the flexible tubing 132 to a bed rail. The attachment element 142 is typically a clip, a hanger, and the like, that decreases the likelihood of accidental spillage, by keeping the flexible tubing 132 in place.

The urine collection receptacle 144 is typically a flexible plastic bag or similar storage container capable of holding up to 3.5 liters of fluid. The urine collection receptacle 144 comprises an inlet 146, an outlet 148 and a hanger 152. The inlet 146 may be tubing or a nozzle similar to the nozzle of the outlet 120 from the bed pan 102. The second end 136 of the flexible tubing 132 is attachable to the inlet 146 with a second clamp 140, a clip, by friction, and the like, or may also be permanently integrated with the flexible tubing 132 and manufactured as a single piece. The outlet 148 may comprise a stopcock 150 or similar flow controller for emptying the urine collection receptacle 144. The hanger 152 allows the urine collection receptacle 144 to hang on the bed rail off of the floor. Additionally the urine collection receptacle 144 may further comprise graduated markings 154 to indicate the volume of fluid currently in the urine collection receptacle 144. This is beneficial as many bed pan users need to monitor their urine output. Urine output can accurately be measured by subtracting the volume of fluid discharged by each activation of the trigger 130 from the volume of fluid currently in the urine collection receptacle 144. The urine collection receptacle 144 may further comprise a handle (not shown) for transporting the urine collection receptacle 144 when disposing of collected urine.

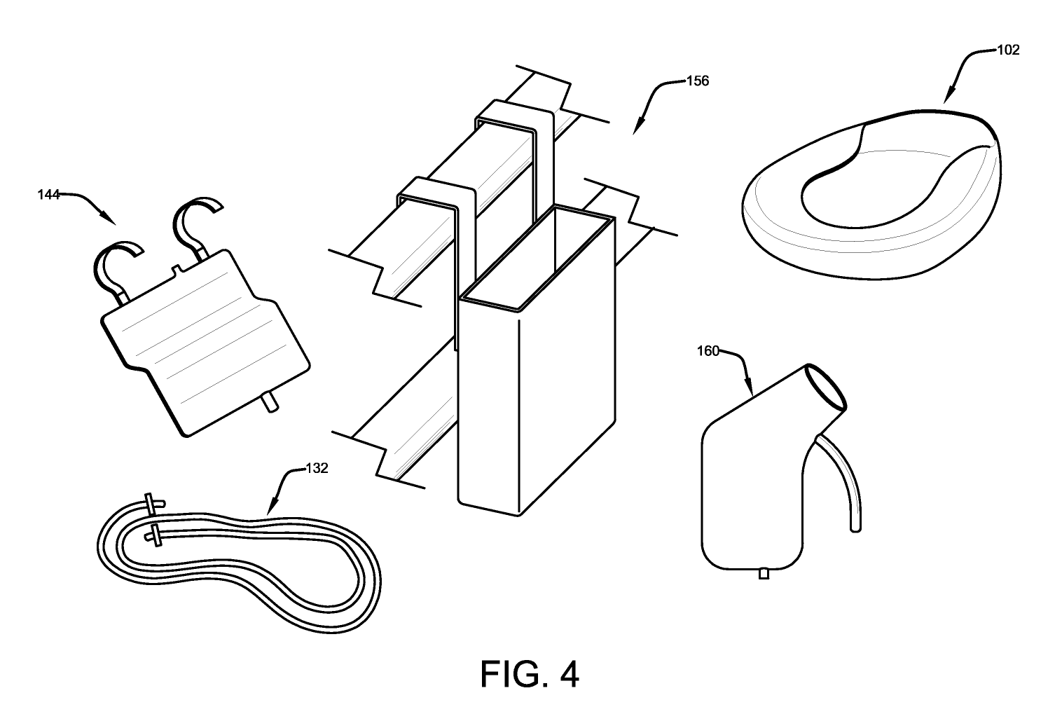

As illustrated in FIGS. 3 and 4, the system for redirecting urine away from a human body may further comprise a urinal 160 for use by male users. The urinal 160 comprises an outlet element 162 penetrating a bottom of the urinal 160 similar to the outlet 120 of the bed pan 120. To use the urinal 160, the user simply removes the first end 134 of the flexible tubing 132 from the outlet 120 of the bed pan 120 and then attaches the first end 134 of the flexible tubing 132 to the outlet element 162 of the urinal 160. The urinal 160 may further comprise a urinal flushing element (not shown) similar to the flushing element 124 of the bed pan 102 housed within an inside of the urinal 160 or attached to an outside of the urinal 160. The urine collection device 100 may further comprise a bedside holder 156 for containing the entire system when not in use. The bedside holder 156 hangs on the bed rail with the bed pan 102, the flexible tubing 132, the urine collection receptacle 144, and the urinal 160 all storable within the bedside holder 156.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention. Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A urine collection device comprising:
a bed pan comprising:
an exterior portion comprising a seating surface;
an interior portion comprising a bottom and a curved sidewall terminating underneath the seating surface;
an outlet penetrating the curved sidewall of the bed pan;
a flushing element housed within the interior portion along the curved sidewall comprising a fluid retaining reservoir, a plurality of liquid dispensing nozzles in fluid communication with the fluid retaining reservoir, and a trigger attached to an exterior of the flushing element for activating the plurality of spray nozzles; and
a urine collection receptacle; and
a flexible tubing for connecting the bed pan to the urine collection receptacle.

2. The urine collection device of claim 1, wherein the outlet penetrates the curved sidewall adjacent to the bottom of the interior portion of the bed pan.

3. The urine collection device of claim 2, wherein the outlet is a one-way valve nozzle.

4. The urine collection device of claim 3, wherein the flexible tubing is removably attached to the nozzle.

5. The urine collection device of claim 1, wherein the urine collection receptacle comprises a bag with graduated markings to indicate a volume of collected liquid.

6. The urine collection device of claim 1, further comprising a bed pan holder.

7. A urine collection device comprising:
a bed pan comprising:
an exterior portion comprising a seating surface;
an interior portion comprising a bottom and a curved sidewall terminating underneath the seating surface;
a one-way valve nozzle penetrating the curved sidewall of the bed pan;
a flushing element housed within the interior portion along the curved sidewall comprising a refillable fluid retaining reservoir, a plurality of liquid dispensing nozzles in fluid communication with the fluid retaining reservoir, and a trigger attached to an exterior of the flushing element for activating the plurality of spray nozzles, wherein the trigger transects the sidewall of the bed pan so that the trigger is accessible from the exterior portion of the bed pan; and
a urine collection receptacle comprising a hanger element; and
a flexible tubing attachable to a bed rail for connecting the bed pan to the urine collection receptacle.

8. The urine collection device of claim 7, wherein the fluid retaining reservoir retains a water based solution.

9. The urine collection device of claim 7, wherein the fluid retaining reservoir retains a disinfectant solution.

10. The urine collection device of claim 9, wherein the fluid retaining reservoir is refillable.

11. The urine collection device of claim 7, wherein the plurality of spray nozzles discharge the disinfectant solution in a generally straight stream pattern.

12. The urine collection device of claim 7, wherein the plurality of spray nozzles discharge the disinfectant solution in a generally arcuate pattern.

13. The urine collection device of claim 7, wherein the plurality of spray nozzles discharge the disinfectant solution outward from the fluid retaining reservoir across the bottom of the interior of the bedpan

14. A system for redirecting urine comprising:
a bed pan comprising:
an exterior portion comprising a seating surface;
an interior portion comprising a bottom and a curved sidewall terminating underneath the seating surface;
an outlet penetrating the curved sidewall of the bed pan;
a flushing element housed within the interior portion along the curved sidewall comprising a fluid retaining reservoir, a plurality of liquid dispensing nozzles in fluid communication with the fluid retaining reservoir, and a trigger attached to an exterior of the flushing element for activating the plurality of spray nozzles; and
a urinal comprising an outlet in a bottom of the urinal;
a urine collection receptacle; and
a flexible tubing for connecting the bed pan or the urinal to the urine collection receptacle.

15. The system of claim 14, wherein the plurality of spray nozzles discharge the disinfectant solution in a plurality of stream patterns.

16. The system of claim 14, wherein the flexible tubing is attached to the outlet of the bed pan or the outlet of the urinal.

17. The system of claim 16, wherein the flexible tubing is attached with a clamp.

18. The system of claim 14, wherein the urinal further comprises a flushing element housed within the urinal.

19. The system of claim 14, wherein the urinal further comprises a flushing element attached to an outside of the urinal.

20. The system of claim 14, further comprising a bed pan holder capable of containing the entire system.
